(19) United States
(12) Patent Application Publication
(10) Pub. No.: US 2024/0044354 A1
(43) Pub. Date: Feb. 8, 2024

(54) FASTENER, ASSEMBLY, AND METHOD OF MAKING AND USING THE SAME

(71) Applicant: Saint-Gobain Performance Plastics Pampus GmbH, Willich (DE)

(72) Inventors: Benedikt KLAPHECK, Düsseldorf (DE); Martin LEFEVRE, Neuss (DE); Natalia Lucia SALAZAR GUARNIZO, Düsseldorf (DE); Alexander JINDRA, Jüchen (DE); Andre FLICK, Willich (DE); Jan ARPE, Willich (DE)

(21) Appl. No.: 18/363,900

(22) Filed: Aug. 2, 2023

Related U.S. Application Data
(60) Provisional application No. 63/370,182, filed on Aug. 2, 2022.

(51) Int. Cl. F16B 33/06; F16B 37/02; F16B 39/282

(52) U.S. Cl. CPC F16B 33/06; F16B 37/02; F16B 39/282

(57) ABSTRACT

A fastener including: a fastener body including a base defining an aperture down a central axis, and first and second opposing major surfaces, and at least one secondary base defining a secondary aperture; and a functional layer overlying the first major surface of the base, where the second opposing major surface is free of the functional layer or is overlaid with a second functional layer different than the first functional layer.

### CROSS-REFERENCE TO RELATED APPLICATION(S)

This application claims priority under 35 U.S.C. § 119(e) to U.S. Provisional Application No. 63/370,182, entitled “FASTENER, ASSEMBLY, AND METHOD OF MAKING AND USING THE SAME,” by Benedikt KLAPHECK et al., filed Aug. 2, 2022, which is assigned to the current assignee hereof and incorporated herein by reference in its entirety.

### FIELD OF THE DISCLOSURE

The present disclosure relates to fasteners, and more particularly to fasteners installed on shafts and/or neighboring components.

### BACKGROUND

A fastener may be disposed to distribute load of a first member, e.g., a shaft in an assembly or mechanism. Specific types of fasteners may be used to axially fix itself to a first member and interact with another component of the assembly.

In a number of assemblies, the first member may encounter unwanted force during usage where the fastener may be urged to move against the side of other components (e.g. housings) of the assembly, such as a second member, which may cause friction, vibration, and noise. There continues to be a need for fasteners for use in applications to better fix to first members and second members and provide decreased stick-slip, vibration, and noise while simplifying assemblies, protecting sensitive surfaces during assembly, and increasing assembly lifetimes.

### BRIEF DESCRIPTION OF THE DRAWINGS

Embodiments are illustrated by way of example and are not limited in the accompanying figures.

FIG. 1 includes a method of producing a fastener in accordance with an embodiment;

FIG. 2A includes a cross-sectional view of a fastener in accordance with an embodiment;

FIG. 2B includes a cross-sectional view of a fastener in accordance with an embodiment;

FIG. 2C includes a cross-sectional view of a fastener in accordance with an embodiment;

FIG. 3A includes a top view illustration of an unfinished blank cut fastener in accordance with an embodiment;

FIG. 3B includes a top view illustration of a finished fastener formed from the unfinished fastener of FIG. 3A, in accordance with an embodiment;

FIG. 4 includes a side view of a fastener in accordance with an embodiment;

FIG. 5 includes a top view of a finished fastener in accordance with an embodiment;

FIG. 6A includes a side view of a finished fastener in accordance with an embodiment;

FIG. 6B includes a side view of a finished fastener in accordance with an embodiment;

FIG. 6C includes a side view of a finished fastener in accordance with an embodiment;

FIG. 6D includes a side view of a finished fastener in accordance with an embodiment;

FIG. 6E includes a side view of a finished fastener in accordance with an embodiment;

FIG. 6F includes a side view of a finished fastener in accordance with an embodiment;

FIG. 6G includes a side view of a finished fastener in accordance with an embodiment;

FIG. 7A includes a side view of a finished fastener within an assembly in accordance with an embodiment;

FIG. 7B includes a side view of a finished fastener within an assembly in accordance with an embodiment; and

FIG. 8 includes a view of a method in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fastener and fastener assembly arts.

Embodiments described herein are generally directed to a fastener including: a fastener body including a base defining an aperture down a central axis, and first and second opposing major surfaces, and at least one secondary base defining a secondary aperture; and a functional layer overlying the first major surface of the base, where the second opposing major surface is free of the functional layer or is overlaid with a second functional layer different than the first functional layer.

Embodiments described herein are generally directed to an assembly including: a first member including a shaft; a second member including a housing; and a fastener disposed between the first member and the second member, the fastener including: a fastener body including a base defining an aperture down a central axis, and first and second opposing major surfaces, and at least one secondary base defining a secondary aperture; and a functional layer overlying the first major surface of the base, where the second opposing major surface is free of the functional layer or is overlaid with a second functional layer different than the first functional layer.

Embodiments described herein are generally directed to a method including: providing a fastener including: a fastener body including a base defining an aperture down a central axis, and first and second opposing major surfaces, and at least one secondary base defining a secondary aperture; and overlaying a functional layer onto the first major surface of the base, where the second opposing major surface is free of the functional layer or is overlaid with a second functional layer different than the first functional layer.

For purposes of illustration, FIG. 1 includes a diagram showing a forming process 10 for forming a fastener. The forming process 10 may include a first step 12 of providing a base material, a second step 14 of overlaying the base material with a functional layer to form a composite material, and a third step 16 of forming the composite material into a fastener.

Referring to the first step 12, the base material may be a substrate. In an embodiment, the substrate can at least partially include a metal. According to certain embodiments, the metal may include iron, copper, titanium, tin, aluminum, alloys thereof, or may be another type of material. More particularly, the substrate can at least partially include a steel, such as, a stainless steel, carbon steel, or spring steel. For example, the substrate can at least partially include a 301 stainless steel. The 301 stainless steel may be annealed, ¼ hard, ½ hard, ¾ hard, or full hard. The substrate may include a woven mesh or an expanded metal grid. Alternatively, the woven mesh can be a woven polymer mesh. In an alternate embodiment, the substrate may not include a mesh or grid.

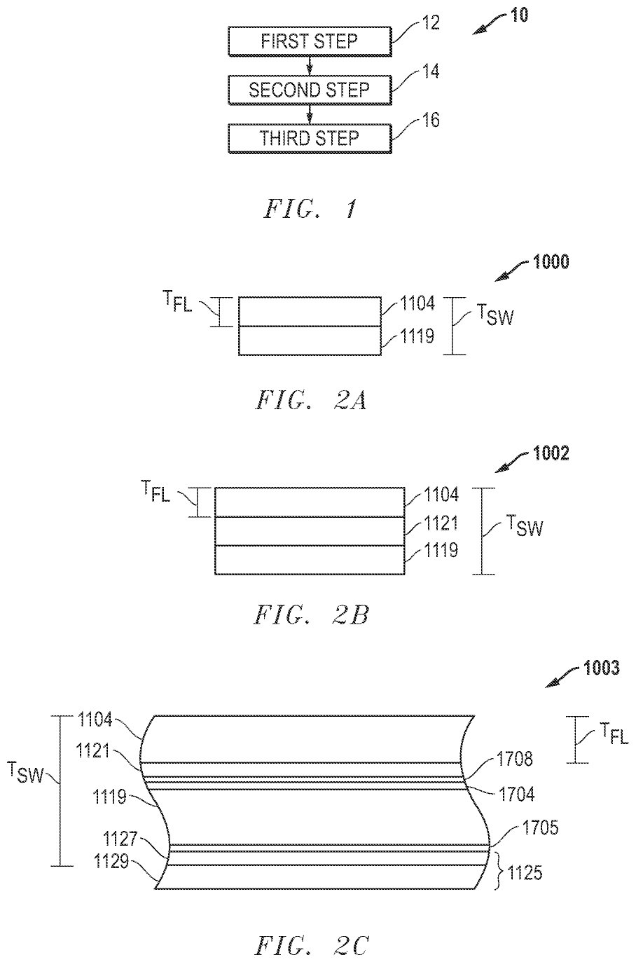

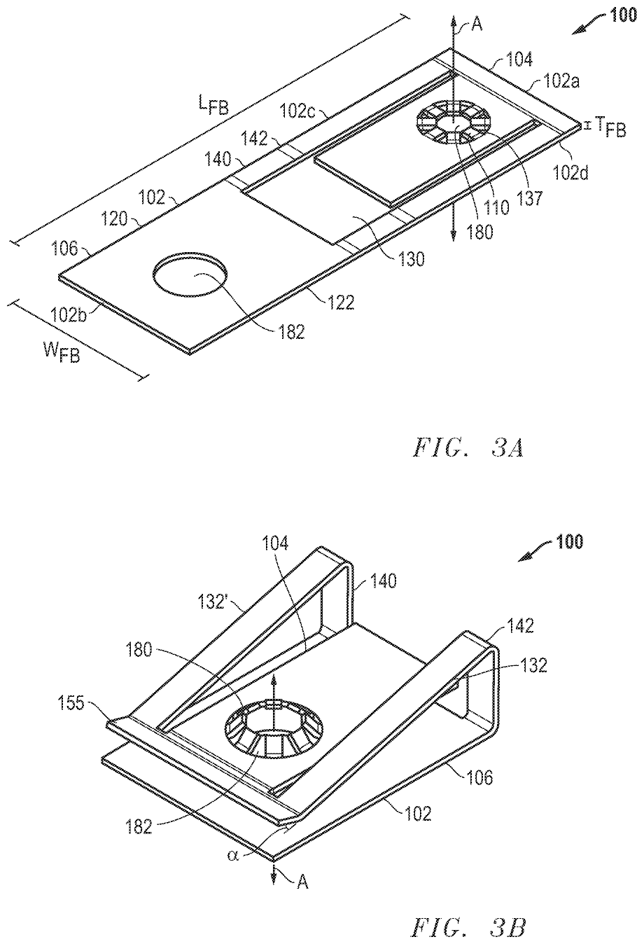

FIG. 2A includes an illustration of the composite material 1000 that may be formed according to first step 12 and second step 14 of the forming process 10. For purposes of illustration, FIG. 2A shows the layer by layer configuration of a composite material 1000 after second step 14. In a number of embodiments, the composite material 1000 may include a substrate 1119 (i.e., the base material provided in the first step 12) and a functional layer 1104 (i.e., the functional layer applied in second step 14). As shown in FIG. 2A, the functional layer 1104 can be coupled to at least a portion of the substrate 1119. In a particular embodiment, the functional layer 1104 can be coupled to a surface of the substrate 1119 so as to form a low friction interface with another surface of another component. The functional layer 1104 can be coupled to the radially inner surface of the substrate 1119 so as to form a low friction interface with another surface of another component. The functional layer 1104 can be coupled to the radially outer surface of the substrate 1119 so as to form a low friction interface with another surface of another component.

In a number of embodiments, the functional layer 1104 can include a low friction layer including a low friction material. Low friction materials may include, for example, a polymer, such as a polyketone, a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. In an example, the functional layer 1104 includes a polyketone, a polyaramid, a polyimide, a polyetherimide, a polyamideimide, a polyphenylene sulfide, a polyphenylene sulfone, a fluoropolymer, a polybenzimidazole, a derivative thereof, or a combination thereof. In a particular example, the low friction layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction layer includes polyketone, such as polyether ether ketone (PEEK), polyether ketone, polyether ketone ketone, polyether ketone ether ketone, a derivative thereof, or a combination thereof. In an additional example, the low friction layer may include an ultra high molecular weight polyethylene (UHMWPE). In an additional example, the low friction layer may include fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyoxymethylene (POM), polyamideimide (PAI), polyphenylene oxide, polyphenylene sulfide (PPS), polyurethane, polyester, liquid crystal polymers (LCP), or any combination thereof. The functional layer 1104 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, lead, iron, bronze, steel, spring steel, stainless steel), a metal alloy (including the metals listed), an anodized metal (including the metals listed), or any combination thereof. Fluoropolymers may be used according to particular embodiments. As used herein, a “low friction material” can be a material having a dry static coefficient of friction as measured against steel of less than 0.5, such as less than 0.4, less than 0.3, or even less than 0.2. A “high friction material” can be a material having a dry static coefficient of friction as measured against steel of greater than 0.6, such as greater than 0.7, greater than 0.8, greater than 0.9, or even greater than 1.0.

In a number of embodiments, the functional layer 1104 may include a damping layer. The damping layer may include a damping material. In a number of embodiments, the functional layer 1104 may include a damping material including at least one of fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), natural polyisoprene, synthetic polyisoprene, polybutadiene, chloroprene rubber, butyl rubber, styrene-butadiene rubber, nitrile rubber, ethylene propylene, rubber, ephichlorohydrin rubber, polyacrylic rubber, silicone rubber, fluorosilicone rubber, fluoroelastomers, perfluoroelastomers, polyether block amides, chlorosulfonated polyethylene, ethyl-vinyl acetate (EVA), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. In a number of embodiments, the damping material can include a foam comprising at least one of EVA foam, low-density polyethylene foam, nitrile rubber foam, polychloroprene foam, polyimide foam, polypropylene foam, polyurethane foam, polystyrene foam, polyvinyl chloride foam, silicone foam, foam rubber, polyurethane foam, XPS foam, epoxy foam, phenolic foam, or any combination thereof.

In a number of embodiments, the functional layer 1104 may include a fabric. The fabric may include metals, such as bronze, steel, aluminum; polymers as polyketone, such as polyether ether ketone (PEEK), polyether ketone, polyether ketone ketone, polyether ketone ether ketone, a derivative thereof, or a combination thereof. In an additional example, the low friction layer may include an ultra high molecular weight polyethylene (UHMWPE). In an additional example, the low friction layer may include fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyoxymethylene (POM), polyamideimide (PAI), polyphenylene oxide, polyphenylene sulfide (PPS), polyurethane, polyester, liquid crystal polymers (LCP); glass fiber, aramid fiber, carbon fiber, natural fiber (plant fiber, animal hair), or any combination thereof. In a number of embodiments, any of the above may be combined to form the fabric.

In a number of embodiments, the functional layer 1104 may include a ceramic. The ceramic may include a glass filler, silica, clay mica, aluminum oxide, kaolin, lithium soap, graphite, boron nitride, molybdenum disulfide, tungsten disulfide, polytetrafluoroethylene, carbon nitride, tungsten carbide, or diamond like carbon. In a number of embodiments, any of the above may be combined to form the ceramic.

In a number of embodiments, the functional layer 1104 may further include fillers, including glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitride, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof.

In an embodiment, the functional layer 1104 can have an axial height T_{FL} in a range of 0.01 mm and 2 mm, such as in a range of 0.15 mm and 1 mm, or even in a range of 0.2 mm and 0.75 mm. The axial height of the low friction 1104 may be uniform, i.e., an axial height at a first location of the functional layer 1104 can be equal to an axial height at a second location therealong. The functional layer 1104 may overlie one major surface of the substrate 1119, shown, or overlie both major surfaces. In a number of embodiments, the substrate 1119 may extend at least partially along a length of the composite material 1000. The substrate 1119 may be at least partially encapsulated by the functional layer 1104. That is, the functional layer 1104 may cover at least a portion of the substrate 1119. Axial surfaces of the substrate 1119 may or may not be exposed from the low friction 1104. In an embodiment, the composite material 1000 can have an axial height T_{SW} in a range of 0.01 mm and 5 mm, such as in a range of 0.15 mm and 2.5 mm, or even in a range of 0.2 mm and 1 mm.

FIG. 2B includes an illustration of an alternative embodiment of the composite material that may be formed according to first step 12 and second step 14 of the forming process 10. For purposes of illustration, FIG. 2B shows the layer by layer configuration of a composite material 1002 after second step 14. According to this particular embodiment, the composite material 1002 may be similar to the composite material 1000 of FIG. 2A, except this composite material 1002 may also include at least one adhesive layer 1121 that may couple the functional layer 1104 to the substrate 1119 (i.e., the base material provided in the first step 12) and a functional layer 1104 (i.e., the functional layer applied in second step 14). In another alternate embodiment, the substrate 1119, as a solid component, woven mesh or expanded metal grid, may be embedded between at least one adhesive layer 1121 included between the functional layer 1104 and the substrate 1119.

The adhesive layer 1121 may include any known adhesive material common to the fastener arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. The adhesive layer 1121 can have an axial height of about 1 to 50 microns, such as about 7 to 15 microns.

FIG. 2C includes an illustration of an alternative embodiment of the composite material that may be formed according to first step 12 and second step 14 of the forming process 10. For purposes of illustration, FIG. 2C shows the layer by layer configuration of a composite material 1003 after second step 14. According to this particular embodiment, the composite material 1003 may be similar to the composite material 1002 of FIG. 2B, except this composite material 1003 may also include at least one corrosion protection layer 1704, 1705, and 1708, and a corrosion resistant coating 1125 that can include an adhesion promoter layer 1127 and an epoxy layer 1129 that may couple to the substrate 1119 (i.e., the base material provided in the first step 12) and a functional layer 1104 (i.e., the functional layer applied in second step 14).

The substrate 1119 may be coated with corrosion protection layers 1704 and 1705 to prevent corrosion of the composite material 1003 prior to processing. Additionally, a corrosion protection layer 1708 can be applied over layer 1704. Each of layers 1704, 1705, and 1708 can have an axial height of about 1 to 50 microns, such as about 7 to 15 microns. Layers 1704 and 1705 can include a phosphate of zinc, iron, manganese, or any combination thereof, or a nano-ceramic layer. Further, layers 1704 and 1705 can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Layer 1708 can include functional silanes, nano-scaled silane based primers, hydrolyzed silanes, organosilane adhesion promoters, solvent/water based silane primers. Corrosion protection layers 1704, 1706, and 1708 can be removed or retained during processing.

The composite material 1003 may further include a corrosion resistant coating 1125. The corrosion resistant coating 1125 can have an axial height of about 1 to 50 microns, such as about 5 to 20 microns, and such as about 7 to 15 microns. The corrosion resistant coating 1125 can include an adhesion promoter layer 1127 and an epoxy layer 1129. The adhesion promoter layer 1127 can include a phosphate of zinc, iron, manganese, tin, or any combination thereof, or a nano-ceramic layer. The adhesion promoter layer 1127 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The epoxy layer 1129 can be a thermal cured epoxy, a UV cured epoxy, an IR cured epoxy, an electron beam cured epoxy, a radiation cured epoxy, or an air cured epoxy. Further, the epoxy layer 1129 can include polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy layer 1129 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof.

In an embodiment, under step 14 of FIG. 1, any of the layers on the composite material 1000, 1002, 1003, as described above, can each be disposed in a roll and peeled therefrom to join together under pressure, at elevated temperatures (hot or cold pressed or rolled), by an adhesive, or by any combination thereof. Any of the layers of the composite material 1000, as described above, may be laminated together such that they at least partially overlap one another. Any of the layers on the composite material 1000, 1002, 1003, as described above, may be applied together using coating technique, such as, for example, physical or vapor deposition, spraying, plating, powder coating, or through other chemical or electrochemical techniques. In a particular embodiment, the functional layer 1104 may be applied by a roll-to-roll coating process, including for example, extrusion coating. The functional layer 1104 may be heated to a molten or semi-molten state and extruded through a slot die onto a major surface of the substrate 1119. In another embodiment, the functional layer 1104 may be cast or molded.

In other embodiments, under step 14 of FIG. 1, any of the layers on the composite material 1000, 1002, 1003, as described above, may be applied by a coating technique, such as, for example, physical or vapor deposition, spraying, plating, powder coating, or through other chemical or electrochemical techniques. In a particular embodiment, the functional layer 1104 may be applied by a roll-to-roll coating process, including for example, extrusion coating. The functional layer 1104 may be heated to a molten or semi-molten state and extruded through a slot die onto a major surface of the substrate 1119. In another embodiment, the functional layer 1104 may be cast or molded.

Referring now to the third step 16 of the forming process 10 as shown in FIG. 1, according to certain embodiments, forming the composite material 1000, 1002, 1003 into a fastener may include a cutting operation. In an embodiment, the cutting operation may include use of a stamp, press, punch, saw, or may be machined in a different way. In a number of embodiments, the cutting operation may form a peripheral surface on the fastener. The cutting operation may define a cutting direction initiated from a first major surface to a second major surface, opposite the first major surface, to form the peripheral surfaces or edges. Alternatively, the cutting operation may define a cutting direction initiated from the second major surface to the first major surface to form the peripheral surfaces or edges. Optionally, the composite material 1000, 1002, 1003 may be bent, molded, or machined to the appropriate shape to form the fastener.

Turning now to the fastener formed according to some embodiments described herein, FIG. 3A includes a top view illustration of an unfinished blank cut fastener 100 in accordance with an embodiment. For purposes of illustration, FIG. 3A shows a top view of a composite material cut into an unfinished blank cut fastener 100 before it is machined in accordance with embodiments described herein, which can include a fastener body 102 oriented about a central axis A with a first major surface 120 and a second major surface 122. The fastener body 102 may have a first end 102a, a second end 102b, a third end 102c, and a fourth end 102d. The fastener 100 may further have a base 104. In a number of embodiments, the base 104 may have a rectilinear cross-section. In a number of embodiments, the base 104 may have a polygonal cross-section. In a number of embodiments, the base 104 may have an arcuate cross-section. The base 104 may at least partially define an aperture 180 in the fastener 100. The aperture 180 may have a polygonal, oval, circular, semi-circular, or substantially circular cross-section when viewed in a plane generally perpendicular to the central axis A. The aperture 180 may be non-uniform in shape. The base 104 may include a cutout 130. The at least one cutout 130 may include a polygonal, rectilinear, or arcuate shape. The fastener 100 may further include at least one secondary base 106 defining a secondary aperture 182. The secondary aperture 182 may have a polygonal, oval, circular, semi-circular, or substantially circular cross-section when viewed in a plane generally perpendicular to the central axis A. The secondary aperture 182 may be non-uniform in shape. In a number of embodiments, the secondary base 106 may have a rectilinear cross-section. In a number of embodiments, the secondary base 106 may have a polygonal cross-section. In a number of embodiments, the secondary base 106 may have an arcuate cross-section. The base 104 may connect or be coupled to the secondary base 106 by a bridge portion 140 including at least one pliable portion 142. In a number of embodiments, the functional layer described above may overlie a first major surface 120 while the second major surface 122 is free of functional layer. As a result, the base 104 (or secondary base 106) may define first and second opposing major surfaces 120, 122, where the functional layer overlies the first major surface 120 of the base 104, wherein the second opposing major surface 122 of the base 104 is free of functional layer. In a number of embodiments, the functional layer described above may overlie a second major surface 122 while the first major surface 120 is free of functional layer. As a result, the base 104 (or secondary base 106) may define first and second opposing major surfaces 120, 122, where the functional layer overlies the first major surface 120 of the base 104, wherein the second opposing major surface 122 of the base 104 is free of functional layer. In a number of embodiments, a first functional layer described above may overlie the first major surface 120, while a second functional layer described above may overlie the second major surface 122. The first functional layer may be different in composition from the second functional layer.

In a number of embodiments, the fastener body 102 may have a particular length L_{FB}. For purposes of embodiments described herein and as shown in FIG. 3A, the length L_{FB} of the fastener body 102 is the first end 102a to the second end 102b. According to certain embodiment, the length L_{FB} of the fastener body 102 may be at least about 1 mm, such as, at least about 10 mm or at least about 20 mm or at least about 30 mm or at least about 40 mm or even at least about 50 mm. According to still other embodiments, the length L_{FB} of the fastener body 102 may be not greater than about 100 mm, such as, not greater than about 50 mm or even not greater than about 25 mm. It will be appreciated that the length L_{FB} of the fastener body 102 may be within a range between any of the minimum and maximum values noted above. It will be further appreciated that the length L_{FB} of the fastener body 102 may be any value between any of the minimum and maximum values noted above. For example, the length L_{FB} of the fastener body 102 may be 55 mm.

In a number of embodiments, the fastener body 102 may have a particular width W_{FB}. For purposes of embodiments described herein and as shown in FIG. 3A, the width W_{FB} of the fastener body 102 is the distance from the third end 102c to the fourth end 102d. According to certain embodiment, the width W_{FB} of the fastener body 102 may be at least about 1 mm, such as, at least about 10 mm or at least about 20 mm or at least about 30 mm or at least about 40 mm or even at least about 50 mm. According to still other embodiments, the width W_{FB} of the fastener body 102 may be not greater than about 90 mm, such as, not greater than about 50 mm or even not greater than about 25 mm. It will be appreciated that the width W_{FB} of the fastener body 102 may be within a range between any of the minimum and maximum values noted above. It will be further appreciated that the width W_{FB} of the fastener body 102 may be any value between any of the minimum and maximum values noted above. For example, the width W_{FB} of the fastener body 102 may be 23 mm.

In a number of embodiments, the fastener body 102 may have a particular axial height T_{FB}. For purposes of embodiments described herein and as shown in FIG. 3A, the axial height T_{FB} of the fastener body 102 is the distance from the first major surface 120 to the second major surface 122. In a number of embodiments, the axial height T_{FB} may include deep drawn regions, coined regions, bent regions, or areas of surface roughness. For example, as shown in FIG. 3B, the radial tabs 110 may be bent upward to provide a larger axial height T_{FB}. According to certain embodiment, the axial height T_{FB} of the fastener body 102 may be at least about 0.01 mm, such as, at least about 0.1 mm or at least about 0.2 mm or at least about 0.3 mm or at least about 0.4 mm or even at least about 0.5 mm. According to still other embodiments, the axial height T_{FB} of the fastener body 102 may be not greater than about 5 mm, such as, not greater than about 2 mm or even not greater than about 1 mm. It will be appreciated that the axial height T_{FB} of the fastener body 102 may be within a range between any of the minimum and maximum values noted above. It will be further appreciated that the axial height T_{FB} of the fastener body 102 may be any value between any of the minimum and maximum values noted above. For example, the axial height T_{FB} of the fastener body 102 may be 0.7 mm.

Still referring to FIG. 3A, the fastener 100 may include at least one tab 110. In a number of embodiments, the fastener 100 may include a plurality of tabs 110. In a number of embodiments, the tab 110 may run the entire circumference of at least one of the aperture 180 or secondary aperture 182 of the fastener 100. According to still other embodiments, the fastener 100 may include a plurality of tabs 110, each extending from the aperture 180 or the secondary aperture 182. According to yet other embodiments, the at least one tab 110 may project radially inwardly and be oriented inwards from the aperture 180 or the secondary aperture 182. The at least one tab 110 may include a polygonal, rectilinear, or arcuate shape. In a number of embodiments, the tabs 110 can be circumferentially offset from one another. In embodiments with a plurality of tabs 110, the tabs 110 can be circumferentially offset from one another by a plurality of radial slots 137. In a number of embodiments, the at least on tab 110 may be adapted to deform upon insertion of a neighboring component within the aperture 180 or secondary aperture 182.

FIG. 3B includes a top view illustration of a finished fastener 100 formed from the unfinished fastener of FIG. 3A, in accordance with an embodiment. As shown in FIG. 3B, the unfinished fastener of FIG. 3A has been bent and folded over such that the aperture 180 and second aperture 182 at least partially align down the central axis A, forming a finished fastener 100 according to a number of embodiments. The fastener 100 may be any shape or size and may include a “sheet metal nut,” according to a number of embodiments, as known in the fastener arts. As shown in FIG. 3B, in an embodiment, the first major surface 120 of the base 104 may be parallel to the secondary base 106. Alternatively, in an embodiment as discussed hereafter, the first major surface 120 of the base 104 may be perpendicular to the secondary base 106. As shown, the pliable portion 142 of the bridge portion 140 may be folded to form the finished fastener 100. As a result, due to the cutout 130, a plurality of ribs 132, 132′ may be formed in the fastener body 102. In an embodiment, the ribs 132, 132′ may be oriented axially and extend away from at least one of the base 104 or the secondary base 106. In an embodiment, the ribs 132, 132′ may be oriented radially and extend away from at least one of the base 104 or the secondary base 106.

In an embodiment, as shown in FIG. 3B, the base 104 or secondary base 106 may include an angled ledge 155 formed on the first end 102a or the second end 102b. In certain embodiments, the angled ledge 155 can form an angle α with respect to the plane parallel to the base 104 and perpendicular to the central axis A. By way of a non-limiting embodiment, the angle α between the angled ledge 155 and the base 104 in the unloaded state can be 0°, can be at least 0.1°, such as at least 2°, at least 4°, at least 5°, or even at least 10°. In another embodiment, the angle α can be no greater than 180°, such as no greater than 160°, no greater than 135°, no greater than 120°, no greater than 115°, or even no greater than 90°. In still another embodiment, the angle α can be no less than or equal to 30°. It will be appreciated that the angle α may be within a range between any of the minimum and maximum values noted above. It will be further appreciated that the angle α may be any value between any of the minimum and maximum values noted above. For example, the angle α may be 43°. In a number of embodiments, the angled ledge 155 may have a first angle and a second angle that may be the same or may be different.

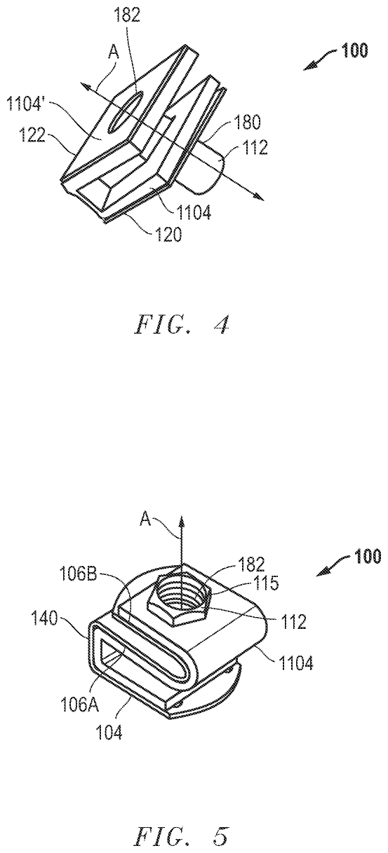

FIG. 4 includes a side view of a finished fastener 100 in accordance with an embodiment. It will be appreciated that corresponding components between FIG. 4 (i.e., components having the same reference number) may be described as having any of the characteristics or features described in reference to FIGS. 3A-3B. In a number of embodiments, the fastener 100 may include an aperture extension 112. The aperture extension 112 may provide a hollow-walled bore extending axially along the central axis A. In a number of embodiments, the aperture extension 112 may run the entire circumference of at least one of the aperture 180 or secondary aperture 182 of the fastener 100. The aperture extension 112 may have a polygonal, oval, circular, semi-circular, or substantially circular cross-section when viewed in a plane generally perpendicular to the central axis A. The aperture extension 112 may be non-uniform in shape. As shown in FIG. 4, a first functional layer 1104 may be formed on the first major surface 120 while a second functional layer 1104′ may be formed on the second major surface 122, as described above. Therefore, the axial interior of the fastener 100 may include functional layer 1104 while the axial exterior of the fastener 100 may be free of functional layer 1104. Alternatively, the axial exterior of the fastener 100 may include functional layer 1104 while the axial interior of the fastener 100 may be free of functional layer 1104. In the embodiment shown in FIG. 4, the functional layer 1104 comprises a damping layer comprising foam.

FIG. 5 includes a top view of a finished fastener 100 in accordance with an embodiment. It will be appreciated that corresponding components between FIG. 5 (i.e., components having the same reference number) may be described as having any of the characteristics or features described in reference to FIGS. 3A-4. As shown in FIG. 5, the secondary base 106 may be folded upon itself to form a first secondary base portion 106A and a second secondary base portion 106B. In a number of embodiments, the fastener 100 may include an aperture extension 112. The aperture extension 112 may provide a hollow-walled bore extending axially along the central axis A. In a number of embodiments, the aperture extension 112 may run the entire circumference of at least one of the aperture 180 or secondary aperture 182 of the fastener 100. The aperture extension 112 may have a polygonal, oval, circular, semi-circular, or substantially circular cross-section when viewed in a plane generally perpendicular to the central axis A. The aperture extension 112 may be non-uniform in shape. In a number of embodiments, the aperture extension 112 may include plurality of threadings 115. In a number of embodiments, the fastener 100 may include a plurality of threadings 115. In a number of embodiments, the tab 110 may run the entire circumference of at least one of the aperture 180 or secondary aperture 182 of the fastener 100. According to still other embodiments, the fastener 100 may include a plurality of threadings 115, each extending from the aperture 180 or the secondary aperture 182. According to yet other embodiments, the plurality of threadings 115 may project radially inwardly and be oriented inwards from the aperture 180 or the secondary aperture 182. In a number of embodiments, the plurality of threadings 115 may be adapted to deform or contact, upon insertion, a neighboring component within the aperture 180 or secondary aperture 182. As shown in FIG. 5, the functional layer 1104 may be formed on a first major surface 120 while the second major surface 122 is free of functional layer 1104. Therefore, the axial interior of the fastener 100 along the base 104 and first secondary base portion 106A may include functional layer 1104 along with the axial exterior of the second secondary base portion 106B while the axial exterior of the fastener 100 along the base 104 and first secondary base portion 106A and the axial interior of the second secondary base portion 106B may be free of functional layer 1104. Alternatively, the axial exterior of the fastener 100 may include functional layer 1104 along the base 104 and first secondary base portion 106A and the axial interior of the second secondary base portion 106B while the axial interior of the fastener 100 along the base 104 and first secondary base portion 106A and the axial exterior of the second secondary base portion 106B along the base 104 and first secondary base portion 106A may be free of functional layer 1104. It is contemplated herein that a first major surface 120 of the fastener may include functional layer 1104 while the second major surface 122 of the fastener is free of functional layer however the fastener 100 is manipulated structurally (e.g. folded). It is also contemplated herein that a second major surface 122 of the fastener may include functional layer 1104 while the first major surface 120 of the fastener is free of functional layer however the fastener 100 is manipulated structurally (e.g. folded).

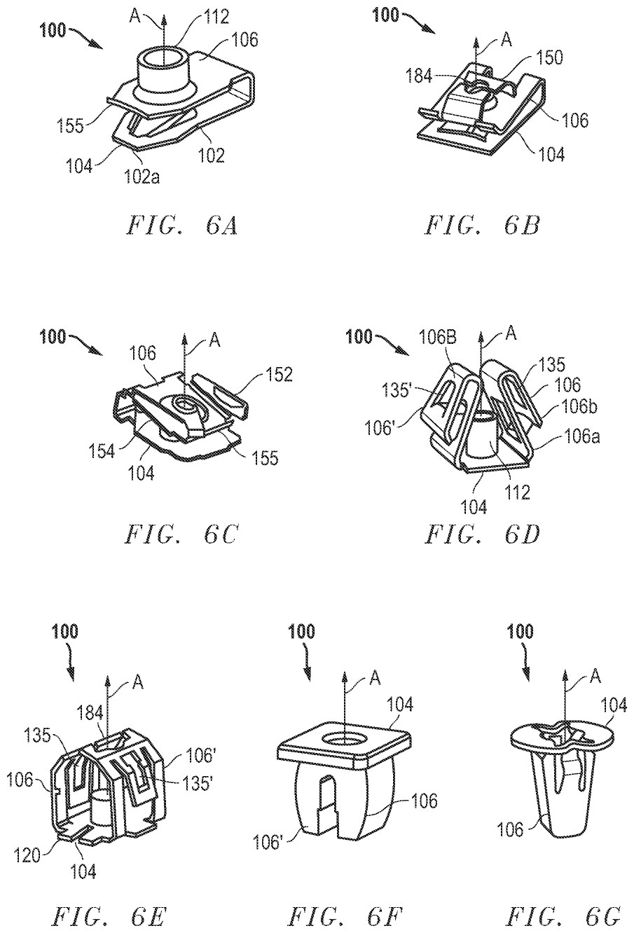

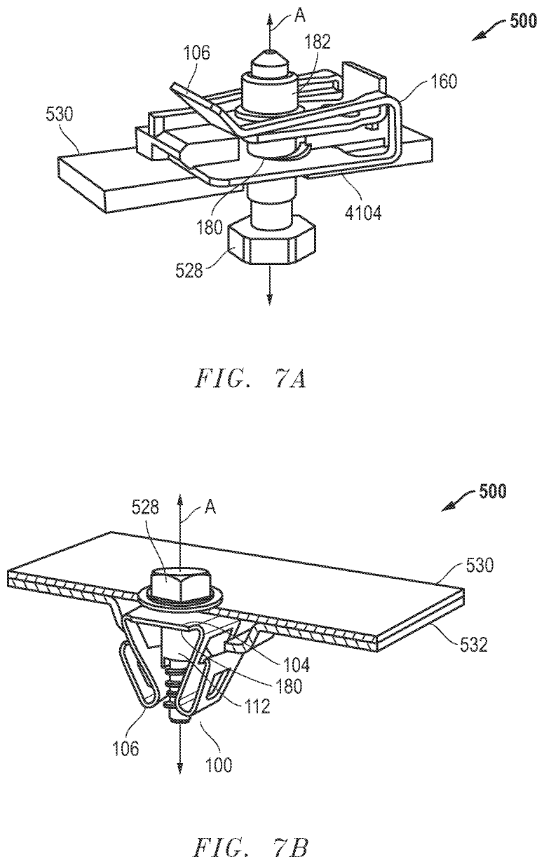

FIGS. 6A-6G include side views of a finished fastener 100 according to a number of embodiments. It will be appreciated that corresponding components between FIGS. 6A-6G (i.e., components having the same reference number) may be described as having any of the characteristics or features described in reference to FIGS. 3A-5. FIG. 6A illustrates a fastener 100 where the secondary base 106 has the aperture extension 112 and where the base 104 may be tapered at a first end 102a of the fastener body 102. FIG. 6B illustrates a fastener 100 with a secondary base 106 forming a rounded protrusion 150 that forms a third aperture 184 along the central axis A. The protrusion 150 could be integral with the secondary base 106. The protrusion 150 could include a split near the third aperture 184. FIG. 6C illustrates a fastener 100 with a secondary base 106 forming a plurality of flanged sides 152, 154 that orient axially along the central axis A. FIG. 6D illustrates a fastener 100 with a base 104 and a plurality of secondary bases 106, 106′. As shown in FIG. 6D, the secondary bases 106, 106′ can be oriented along the central axis A and include first secondary base portions 106A, second secondary base portions 106B, and cutouts 135, 135′. As shown in FIG. 6D, in an embodiment, the fastener 100 may include a plurality of secondary bases 106, 106′ where the first major surface 120 of the base 104 may be on a different plane than the secondary base(s) 106, 106′. FIG. 6E illustrates a fastener 100 with a base 104 and a plurality of secondary base(s) 106, 106′ where the first major surface 120 of the base 104 may be perpendicular to the secondary base(s) 106, 106′. In this embodiment, the secondary base(s) 106, 106′ may be integral and join to form the third aperture 184. FIGS. 6F and 6G illustrate a fastener 100 where the secondary bases 106, 106′ may be integral. All embodiments disclosed herein are within the scope of the invention.

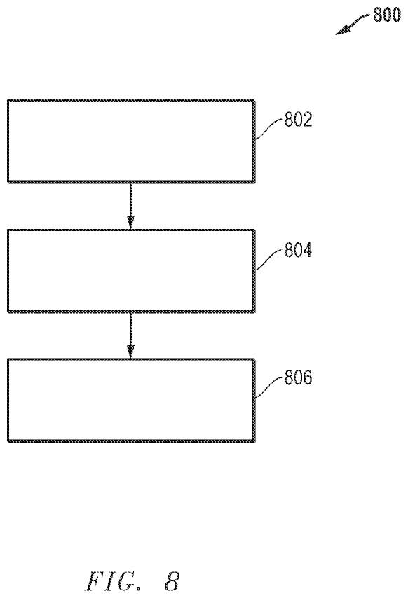

For purposes of illustration, FIGS. 7A-7B include side views of a finished fastener 100 within an assembly 500 in accordance with alternative embodiments described herein. It will be appreciated that corresponding components between FIGS. 3A-6G (i.e., components having the same reference number) may be described as having any of the characteristics or features described in reference to FIGS. 3A-6G. As shown in FIGS. 7A-7B, in a number of embodiments, the fastener 100 can be disposed adjacent to, or contacting, a first member 528 (such as a shaft) in an assembly 500. The assembly 500 may also include a second member 530 (such as a bearing, housing, a side member, or other structural member) fitted on the first member 528. In a number of embodiments, the fastener 100 may be fixed or clipped onto the second member 530 through the base 104 and the secondary base 106 while the first member 528 is fixed to the fastener 100 through at least one of the aperture 180 or secondary aperture 182. In an embodiment, the second member 530 may be adapted to rotate relative to the first member 528. In another embodiment, the first member 528 may be adapted to rotate relative to the second member 530. In an embodiment, the first member 528 may be axially adjacent to at least a part of the second member 530. The fastener 100 can be disposed adjacent to, or contacting, a first member 528 in an assembly 500. In a number of embodiments, the fastener 100 may be installed on the first member 528 in the assembly 500. In a number of embodiments, at least one of the aperture 180 or the secondary aperture 182 may fix the fastener 100 to the first member 528 in the assembly 500. Further, in a number of embodiments, at least one of the base 104 or secondary base 106 may fix the fastener 100 to the second member 530 in the assembly 500. In a number of embodiments, the fastener 100 may be fixed or clipped to a plurality of members to form an assembly. By non-limiting example, in certain embodiments as shown in FIG. 7B, the fastener 100 can connect a first member 528 with at least a second member 530 and a third member 532 secured by a first member 528 (e.g. screw or bolt) using the apertures 180 and 182.

In a number of embodiments, at least one of the first major surface 120 or a second major surface 122 of the fastener 100 may be engaged with the second member 530 so as to prevent or restrict relative movement between the fastener 100 and the first member 528. The movement may be prevented or restricted in a rotational, axial, or radial direction with respect to the central axis A. In a number of embodiments, at least one of the first major surface 120 or a second major surface 122 of the fastener 100 may be engaged with the first member 528 so as to prevent or restrict relative movement between the fastener 100 and the second member 530. The movement may be prevented or restricted in a rotational, axial, or radial direction with respect to the central axis A. According to a particular embodiment, relative axial movement may be prevented. In an embodiment, the fastener 100 can provide a retention force on the first member 528 or second member 530 of at least 1 N under a strain of less than 10 mm.

In an embodiment, the assembly 500 can be installed or assembled by an assembly force of at least 10 N in a longitudinal direction relative to the first member 528, such as at least 20 N, at least 30 N, at least 40 N, at least 50 N, at least 100 N, or even at least 150 N. In a further embodiment, the assembly 500 can be installed or assembled by an assembly force of at least 1 kgf in a longitudinal direction relative to the first member 528, such as no greater than 1500 N, no greater than 1000 N, no greater than 750 N, or even no greater than 250 N.

FIG. 8 shows a method 800 according to a number of embodiments. As shown in FIG. 8, the method 800 may include a first step 802 of providing a fastener 100 including a fastener body 102 including a base 104 defining an aperture 180 down a central axis A, and first and second opposing major surfaces 120, 122, and at least one secondary base 106 defining a secondary aperture 182. The method 800 may further include a second step 804 of overlaying a functional layer 1104 onto the first major surface 120 of the base 104, where the second opposing major surface 122 is free of functional layer 1104. Optionally, the method may further include a third step 804 of installing the fastener 100 between a first member 528 and a second member 530 to form an assembly 500.

Use of the fastener 100 or assembly 500 may provide increased benefits in several applications such as, but not limited to, vehicle tail gates, vehicle fenders, vehicle windows, vehicle headlights, vehicle roof panels, bumpers, vehicle panels, airbags, dashboards, fuel tanks, vehicle suspensions, vehicle exhaust assemblies, vehicle trim assemblies, speaker mountings, ventilation/AC assemblies, door frames, seat assemblies, mating of neighboring components, or other types of applications. Notably, the use of the fastener 100 may provide a simplification of the assembly 500 by eliminating components and increasing ease of assembly. Further, use of the fastener 100 may improve assembly forces required, compensate for axial tolerances and correct misalignment between the inner and second members 28, 30, and provide noise reduction and vibration decoupling within the assembly 500 by preventing undesired movement between the inner and second members 28, 30. Further, the fastener 100 may be a simple installation and be retrofit, reusable, and cost effective across several possible assemblies of varying complexity. Further, the functional layer 1104 on the fastener 100 may provide low friction properties and act as an axial bearing while still being a fixation element against a component of the assembly 500. This can improve the friction performance and corrosion resistance between the fastener 100 and other components of the assembly 500. Further, the functional layer 1104 on the fastener 100 may provide surface protection and avoid scratches or abrasions on a neighboring component of the assembly 500. This can improve the friction performance and corrosion resistance between the fastener 100 and other components of the assembly 500. Lastly, the use of the fastener 100 may maintain the improved stiffness and tensile strength between the inner and second members 28, 30, increasing the lifetime of the assembly 500.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A fastener comprising: a fastener body comprising a base defining an aperture down a central axis, and first and second opposing major surfaces, and at least one secondary base defining a secondary aperture; and a functional layer overlying the first major surface of the base, wherein the second opposing major surface is free of the functional layer or is overlaid with a second functional layer different than the first functional layer.

Embodiment 2: An assembly comprising: a first member comprising a shaft; a second member comprising a housing; and a fastener disposed between the first member and the second member, the fastener comprising: a fastener body comprising a base defining an aperture down a central axis, and first and second opposing major surfaces, and at least one secondary base defining a secondary aperture; and a functional layer overlying the first major surface of the base, wherein the second opposing major surface is free of the functional layer or is overlaid with a second functional layer different than the first functional layer.

Embodiment 3: A method comprising: providing a fastener comprising: a fastener body comprising a base defining an aperture down a central axis, and first and second opposing major surfaces, and at least one secondary base defining a secondary aperture; and overlaying a functional layer onto the first major surface of the base, wherein the second opposing major surface is free of the functional layer or is overlaid with a second functional layer different than the first functional layer.

Embodiment 4: The fastener, assembly, or method of any of the preceding embodiments, wherein the first major surface of the base is parallel to the secondary base.

Embodiment 5: The fastener, assembly, or method of any of the preceding embodiments, wherein the first major surface of the base is perpendicular to the secondary base.

Embodiment 6: The fastener, assembly, or method of any of the preceding embodiments, wherein the at least one secondary base comprises a plurality of secondary bases.

Embodiment 7: The fastener, assembly, or method of any of the preceding embodiments, wherein the base is coupled to the at least one secondary base by a bridge section.

Embodiment 8: The fastener, assembly, or method of any of the preceding embodiments, wherein the base comprises a rectilinear cross-section.

Embodiment 9: The fastener, assembly, or method of any of the preceding embodiments, wherein the base comprises a polygonal cross-section.

Embodiment 10: The fastener, assembly, or method of any of the preceding embodiments, wherein the base comprises an arcuate cross-section.

Embodiment 11: The fastener, assembly, or method of any of the preceding embodiments, wherein the secondary base comprises a rectilinear cross-section.

Embodiment 12: The fastener, assembly, or method of any of the preceding embodiments, wherein the secondary base comprises a polygonal cross-section.

Embodiment 13: The fastener, assembly, or method of any of the preceding embodiments, wherein the secondary base comprises an arcuate cross-section.

Embodiment 14: The fastener, assembly, or method of any of the preceding embodiments, wherein the secondary base defines first and second opposing major surfaces, wherein the first major surface of the secondary base is free of functional layer, wherein the functional layer overlies the second opposing major surface of the secondary base.

Embodiment 15: The fastener, assembly, or method of any of the preceding embodiments, wherein the secondary base defines first and second opposing major surfaces, wherein the functional layer overlies the first major surface of the secondary base, wherein the second opposing major surface of the secondary base is free of functional layer.

Embodiment 16: The fastener, assembly, or method of any of the preceding embodiments, wherein the aperture of the base comprises a plurality of radially extending tabs oriented inwards.

Embodiment 17: The fastener, assembly, or method of embodiment 16, wherein at least one of the tabs is adapted to deform.

Embodiment 18: The fastener, assembly, or method of any of the preceding embodiments, wherein the aperture of the base comprises a plurality of radially extending threadings oriented inwards.

Embodiment 19: The fastener, assembly, or method of any of the preceding embodiments, wherein the aperture of the at least one secondary base comprises a plurality of radially extending tabs oriented inwards.

Embodiment 20: The fastener, assembly, or method of embodiment 19, wherein at least one of the tabs is adapted to deform.

Embodiment 21: The fastener, assembly, or method of any of the preceding embodiments, wherein the aperture of the at least one secondary base comprises a plurality of radially extending threadings oriented inwards.

Embodiment 22: The fastener, assembly, or method of any of the preceding embodiments, wherein the base comprises an aperture extension.

Embodiment 23: The fastener, assembly, or method of any of the preceding embodiments, wherein the at least one secondary base comprises an aperture extension.

Embodiment 24: The fastener, assembly, or method of any of the preceding embodiments, wherein the fastener body comprises a plurality of ribs oriented axially and extending away from at least one of the base or the secondary base.

Embodiment 25: The fastener, assembly, or method of any of the preceding embodiments, wherein the fastener body comprises a plurality of ribs oriented radially and extending away from at least one of the base or the secondary base.

Embodiment 26: The fastener, assembly, or method of any of the preceding embodiments, wherein the fastener body comprises a metal comprising at least one of iron, copper, titanium, tin, aluminum, or an alloy thereof.

Embodiment 27: The fastener, assembly, or method of any of the preceding embodiments, wherein the fastener body comprises a metal comprising spring steel.

Embodiment 28: The fastener, assembly, or method of any of the preceding embodiments, wherein the fastener body comprises a polymer comprising at least one of polytetrafluoroethylene (PTFE), a polyamide (PA), a polyether ether ketone (PEEK), a polyimide (PI), a polyamideimide (PAI), a polyphenylene sulfide (PPS), a polyphenylene sulphone (PPSO2), a liquid crystal polymers (LCP), perfluoroalkoxypolymer (PFA), polyoxymethylene (POM), polyethylene (PE), UHMWPE, or a mixture thereof.

Embodiment 29: The fastener, assembly, or method of any of the preceding embodiments, wherein the fastener body comprises a ceramic.

Embodiment 30: The fastener, assembly, or method of any of the preceding embodiments, wherein the functional layer comprises polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.

Embodiment 31: The fastener, assembly, or method of any of the preceding embodiments, wherein the functional layer comprises a functional layer comprising a fluoropolymer.

Embodiment 32: The fastener, assembly, or method of any of the preceding embodiments, wherein the functional layer comprises a damping layer comprising an elastomer comprising at least one of fluorinated ethylene propylene (FEP), PTFE, polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), natural polyisoprene, synthetic polyisoprene, polybutadiene, chloroprene rubber, butyl rubber, styrene-butadiene rubber, nitrile rubber, ethylene propylene, rubber, ephichlorohydrin rubber, polyacrylic rubber, silicone rubber, fluorosilicone rubber, fluoroelastomers, perfluoroelastomers, polyether block amides, chlorosulfonated polyethylene, ethyl-vinyl acetate (EVA), or any combination thereof.

Embodiment 33: The fastener, assembly, or method of any of the preceding embodiments, wherein the functional layer comprises a damping layer comprising a foam comprising at least one of EVA foam, low-density polyethylene foam, nitrile rubber foam, polychloroprene foam, polyimide foam, polypropylene foam, polyurethane foam, polystyrene foam, polyvinyl chloride foam, silicone foam, foam rubber, polyurethane foam, XPS foam, epoxy foam, phenolic foam, or any combination thereof.

Embodiment 34: The fastener, assembly, or method of any of the preceding embodiments, wherein the functional layer comprises at least one of bronze, steel, aluminum; polyether ether ketone (PEEK), polyether ketone, polyether ketone ketone, polyether ketone ether ketone, ultra high molecular weight polyethylene (UHMWPE), fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyoxymethylene (POM), polyamideimide (PAI), polyphenylene oxide, polyphenylene sulfide (PPS), polyurethane, polyester, liquid crystal polymers (LCP), glass fiber, carbon fiber, natural fiber, or any combination thereof.

Embodiment 35: The fastener, assembly, or method of any of the preceding embodiments, wherein the fastener further comprises an adhesive layer disposed between the fastener body and the functional layer.

Embodiment 36: The fastener, assembly, or method of embodiment 34, wherein the adhesive layer comprises at least one of fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof.

Embodiment 37: The fastener, assembly, or method of any of the preceding embodiments, wherein the secondary base defines first and second opposing major surfaces, wherein the first major surface of the secondary base has a first functional layer, wherein a second functional layer overlies the second opposing major surface of the secondary base, different to the first functional layer.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A fastener comprising:
a fastener body comprising a base defining an aperture down a central axis, and first and second opposing major surfaces, and at least one secondary base defining a secondary aperture; and
a functional layer overlying the first major surface of the base, wherein the second opposing major surface is free of the functional layer or is overlaid with a second functional layer different than the first functional layer.

2. An assembly comprising:
a first member comprising a shaft;
a second member comprising a housing; and
a fastener disposed between the first member and the second member, the fastener comprising:
a fastener body comprising a base defining an aperture down a central axis, and first and second opposing major surfaces, and at least one secondary base defining a secondary aperture; and
a functional layer overlying the first major surface of the base, wherein the second opposing major surface is free of the functional layer or is overlaid with a second functional layer different than the first functional layer.

3. A method comprising:
providing a fastener comprising:
a fastener body comprising a base defining an aperture down a central axis, and first and second opposing major surfaces, and at least one secondary base defining a secondary aperture; and
overlaying a functional layer onto the first major surface of the base, wherein the second opposing major surface is free of the functional layer or is overlaid with a second functional layer different than the first functional layer.

4. The fastener of claim 1, wherein the first major surface of the base is parallel to the secondary base.

5. The fastener of claim 1, wherein the first major surface of the base is perpendicular to the secondary base.

6. The fastener of claim 1, wherein the at least one secondary base comprises a plurality of secondary bases.

7. The fastener of claim 1, wherein the base is coupled to the at least one secondary base by a bridge section.

8. The fastener of claim 1, wherein the secondary base defines first and second opposing major surfaces, wherein the first major surface of the secondary base is free of functional layer, wherein the functional layer overlies the second opposing major surface of the secondary base.

9. The fastener of claim 1, wherein the secondary base defines first and second opposing major surfaces, wherein the functional layer overlies the first major surface of the secondary base, wherein the second opposing major surface of the secondary base is free of functional layer.

10. The fastener of claim 1, wherein the aperture of the base comprises a plurality of radially extending tabs oriented inwards.

11. The fastener of claim 1, wherein the aperture of the base comprises a plurality of radially extending threadings oriented inwards.

12. The fastener of claim 1, wherein the aperture of the at least one secondary base comprises a plurality of radially extending tabs oriented inwards.

13. The fastener of claim 1, wherein the base comprises an aperture extension.

14. The fastener of claim 1, wherein the at least one secondary base comprises an aperture extension.

15. The fastener of claim 1, wherein the fastener body comprises a plurality of ribs oriented axially and extending away from at least one of the base or the secondary base.

16. The fastener of claim 1, wherein the fastener body comprises a plurality of ribs oriented radially and extending away from at least one of the base or the secondary base.

17. The fastener of claim 1, wherein the functional layer comprises a damping layer comprising an elastomer comprising at least one of fluorinated ethylene propylene (FEP), PTFE, polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), natural polyisoprene, synthetic polyisoprene, polybutadiene, chloroprene rubber, butyl rubber, styrene-butadiene rubber, nitrile rubber, ethylene propylene, rubber, ephichlorohydrin rubber, polyacrylic rubber, silicone rubber, fluorosilicone rubber, fluoroelastomers, perfluoroelastomers, polyether block amides, chlorosulfonated polyethylene, ethyl-vinyl acetate (EVA), or any combination thereof.

18. The fastener of claim 1, wherein the functional layer comprises a damping layer comprising a foam comprising at least one of EVA foam, low-density polyethylene foam, nitrile rubber foam, polychloroprene foam, polyimide foam, polypropylene foam, polyurethane foam, polystyrene foam, polyvinyl chloride foam, silicone foam, foam rubber, polyurethane foam, XPS foam, epoxy foam, phenolic foam, or any combination thereof.

19. The fastener of claim 1, wherein the functional layer comprises at least one of bronze, steel, aluminum; polyether ether ketone (PEEK), polyether ketone, polyether ketone ketone, polyether ketone ether ketone, ultra high molecular weight polyethylene (UHMWPE), fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyoxymethylene (POM), polyamideimide (PAI), polyphenylene oxide, polyphenylene sulfide (PPS), polyurethane, polyester, liquid crystal polymers (LCP), glass fiber, carbon fiber, natural fiber, or any combination thereof.

20. The fastener of claim 1, wherein the secondary base defines first and second opposing major surfaces, wherein the first major surface of the secondary base has a first functional layer, wherein a second functional layer overlies the second opposing major surface of the secondary base, different to the first functional layer.
